(19) United States
(12) Patent Application Publication
(10) Pub. No.: US 2006/0227041 A1
(43) Pub. Date: Oct. 12, 2006

(54) Apparatus, method and computer program product for calibrating image transform parameter, and obstacle detection apparatus

(75) Inventor: Yasukazu Okamoto, Hyogo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: Kabushiki Kaisha Toshiba, Minato-ku (JP)

(21) Appl. No.: 11/361,763

(22) Filed: Feb. 24, 2006

(30) Foreign Application Priority Data
Mar. 14, 2005 (JP) 2005-071773

(51) Int. Cl. G01S 7/40; G01S 13/93; G01S 13/86

(52) U.S. Cl. 342/174; 342/52; 342/109; 342/54; 342/55; 342/180

(57) ABSTRACT

A calibration apparatus includes an obstacle detection unit that detects an obstacle on an arbitrary surface in a three-dimensional space in one of a plurality of images obtained by taking an image pickup subject from a plurality of directions, by using a transform parameter transforming a point on the surface into a point on the surface of other image, and computes position coordinates of the obstacle on each of the images; and a transform parameter adjustment unit that receives a distance data between an image pickup position and the obstacle, and adjusts the transform parameter with the received distance data and position coordinates of the detected obstacle. The obstacle detection unit detects the obstacle by using the transform parameter adjusted by the transform parameter adjustment unit, and computes the position coordinates of the detected obstacle.

### CROSS-REFERENCE TO RELATED APPLICATIONS

This application is based upon and claims the benefit of priority from the prior Japanese Patent Application No. 2005-071773, filed on Mar. 14, 2005; the entire contents of which are incorporated herein by reference.

### BACKGROUND OF THE INVENTION

1. Field of the Invention

The present invention relates to an apparatus, a method, and a computer program product for adjusting a transform parameter transforming an image taken by one camera into an image taken by the other camera, and an obstacle detection apparatus provided with the calibration apparatus, in an image pickup apparatus which takes stereo images by a plurality of cameras.

2. Description of the Related Art

Currently the technology for detecting an obstacle can mainly be divided into the technology in which laser radar, millimeter wave radar, or the like is utilized and the technology in which a TV camera is utilized. The laser and the millimeter wave radar are relatively expensive, and the laser and the millimeter wave radar have characteristics in which resolution in a spatial direction is low while distance measuring accuracy is high. For example, in the millimeter wave radar whose propagation direction is orientated ahead of the vehicle, position measuring accuracy in a transverse direction is low while the accuracy of the distance to the vehicle going ahead is high. Further, because the laser or the millimeter wave radar cannot recognize a driving lane by itself, it is necessary that the laser or the millimeter wave radar be used in combination with another sensor.

On the other hand, the TV camera is not expensive, and the TV camera is more suitable to the obstacle detection in the spatial-direction resolution and a measuring range, however, the distance measuring accuracy is low, when compared with the radar. Further, the TV camera can recognize the driving lane. In the obstacle detection technology in which the TV camera is used, there are the method using one camera and the method using the plural cameras (stereo-camera).

In the method using one camera, one image taken by the camera is divided into a road region and an obstacle region with a clue of information such as brightness, color, and texture. For example, the road region is determined by extracting a middle brightness region having low chroma, i.e., the gray region or the region having small texture from the image, and other than regions are divided as the obstacle region. However, it is difficult that the obstacle region is distinguished from the road region by this method, because there are many obstacles having the brightnesses, colors, and textures similar to the road.

On the other hand, in the method using the plural cameras, the obstacle is detected with the clue of three-dimensional information on an object taken by the plural cameras. This method is generally called stereopsis method. The stereopsis method means that, for example, the two cameras are arranged on the right and left sides, correspondence of points which are of the identical point in a three-dimensional space is established between the right and left images, and a three-dimensional position of the point is determined by a triangulation technique. When the positions and attitudes or the like of the cameras are previously determined with respect to the road plane, a height from the road plane is obtained at an arbitrary point in the image by the stereopsis method. Therefore, presence or absence of the height can separate the obstacle region and the road region from each other. The stereopsis method can detect the obstacle having the brightness, color, and texture or the like similar to the road.

However, in the general stereopsis method, there are problems of correspondence point detection and camera calibration. The correspondence point detection means detection computation necessary to establish the correspondence of the identical point in the three-dimensional space between the right and left images, and cost of the detection computation is extremely high. Therefore, the correspondence point detection becomes a factor, which prevents practical application of the stereopsis method.

The calibration means operation of computing transform parameters which establish the correspondence of the coordinates of the right and left images, in order to accurately detect the obstacle. The operation is performed as follows. A stereo camera is first mounted on the vehicle in a production process, and a road plane is then taken with a stereo camera while the vehicle is placed on the flat road. After that, the transform parameters are computed based on the coordinate values of some specific points on the road plane, which have been measured, and the coordinate values of the points corresponding to the specific points on the right and left images taken with the stereo camera. Usually it takes a huge time to perform the computation for the camera calibration. Further, because the camera calibration is performed only once in the production process, it is difficult to deal with a short-term fluctuation in transform parameter caused by the vibration of the vehicle, inclination of the road, and the like and a long-term fluctuation in transform parameter caused by a change in camera setting-angle and the like.

In order to solve the difficulty of the correspondence point detection, there is proposed the technology called the planar projection stereopsis method (for example, see Japanese Patent Application Laid-Open (JP-A) No. 2001-76128). In the planar projection stereopsis method, the parameter transforming the point on the image taken by one of the cameras into a projection point on the image taken by the other camera is computed on the assumption that the point on the image taken by one of the cameras exists on the road plane, the taken image is transformed by using the parameter, the road region and the obstacle region are separated from each other by using a difference between the taken image and the transformed image, and thereby the obstacle is detected without performing the correspondence point detection.

JP-A No. 2001-76128 also proposes the method in which, when the change in transform parameter is caused by the vibration of the vehicle or the inclination of the road, the plural appropriate attitudes are selected from an envisioned range of a possible relative relationship between the camera and the road plane, the transform parameters are computed corresponding to all the attitudes, the images transformed by the transform parameters are prepared and compared to one another, the region where a degree of coincidence becomes the lowest is detected as the obstacle, and thereby the short-term fluctuation in transform parameter is dealt with.

The technology, in which a displacement in a vertical direction between the right and left images is monitored in an actual working state to adjust the detected displacement in the vertical direction as needed, is also proposed as the method of dealing with the long-term fluctuation in transform parameter. For example, see Keiji HANAWA, “New developments of vehicle-mounted image sensors in ITS,” 10th Image Sensing Symposium (SSII04) Tutorial Lecture Meeting Text, p. 51-62, 2004 (hereinafter, referred to as “HANAWA's obstacle detection method”).

However, because the HANAWA's obstacle detection method differs from the planar projection stereopsis method in an algorithm for recognizing the obstacle, there is the problem that HANAWA's obstacle detection method cannot be applied to the planar projection stereopsis method. In the planar projection stereopsis method disclosed JP-A No. 2001-76128, there is the problem that an error is generated in the transform parameter to decrease the obstacle detection accuracy by the change in the camera setting-angle generated in the long-term operation.

In the vehicle on which the millimeter wave radar or the like is mounted, in order to perform the processing by combining distance information measured by the radar with information obtained from the image taken by the stereo-camera, the parameter which performs the transform between a coordinate system indicating the radar distance information and a coordinate system indicating the position measured by the image is also required to perform the computation by the calibration working.

### SUMMARY OF THE INVENTION

According to one aspect of the present invention, a calibration apparatus includes an obstacle detection unit that detects an obstacle on an arbitrary surface in a three-dimensional space in one of a plurality of images obtained by taking an image pickup subject from a plurality of directions, by using a transform parameter transforming a point on the surface into a point on the surface of other image, and computes position coordinates of the obstacle on each of the images; and a transform parameter adjustment unit that receives a distance data between an image pickup position and the obstacle, and adjusts the transform parameter with the received distance data and position coordinates of the detected obstacle, wherein the obstacle detection unit detects the obstacle by using the transform parameter adjusted by the transform parameter adjustment unit, and computes the position coordinates of the detected obstacle.

According to another aspect of the present invention, an obstacle detection apparatus includes a plurality of image pickup units that take images; a distance detection unit that detects a distance between an image pickup position and an obstacle on an arbitrary surface in a three-dimensional space; an obstacle detection unit that detects the obstacle from the images taken by the image pickup units by using a transform parameter transforming a point on the surface in an image taken by one of the image pickup units into a point on the surface of an image taken by other image pickup unit, and computes position coordinates of the detected obstacle on the image; and a transform parameter adjustment unit that receives the distance data, and adjusts the transform parameter with the received distance data and the position coordinates of the obstacle, wherein the obstacle detection unit detects the obstacle from the images taken by the image pickup units by using the adjusted transform parameter, and the obstacle detection unit computes the position coordinates of the detected obstacle.

According to still another aspect of the present invention, a calibration method includes detecting an obstacle on an arbitrary surface in a three-dimensional space in one of a plurality of images obtained by taking an image pickup subject from a plurality of directions, by using a transform parameter transforming a point on the surface into a point on the surface of other image; computing position coordinates of the obstacle on each of the images; receiving a distance data between an image pickup position and the obstacle; adjusting the transform parameter with the received distance data and position coordinates of the detected obstacle; further detecting the obstacle by using the adjusted transform parameter; and computing the position coordinates of the detected obstacle.

According to still another aspect of the present invention, a computer program product causes a computer to perform the calibration method according to the present invention.

### BRIEF DESCRIPTION OF THE DRAWINGS

FIG. 1 is a block diagram showing a configuration of a calibration apparatus according to an embodiment of the invention;

FIG. 2 is an explanatory view showing a relationship between an arrangement of an image pickup unit and a road-plane coordinate;

FIG. 3 is a flowchart showing a whole flow of a transform parameter adjustment process in the calibration apparatus according to the embodiment; and

FIG. 4 is a schematic view showing an example of a mask image used in computing a deformation component.

### DETAILED DESCRIPTION OF THE INVENTION

Exemplary embodiments of a calibration apparatus, a calibration method, a calibration program, and an obstacle detection apparatus provided with the calibration apparatus according to the present invention will be described in detail below with reference to the accompanying drawings. In the embodiments, the obstacle detection apparatus used while mounted on a vehicle will be explained as an example.

In a calibration apparatus according to an embodiment, the value of the distance to the obstacle is adjusted by computing the value of the transform parameter again from the distance to the obstacle detected by a distance measuring apparatus such as the radar and the coordinate of the obstacle detected by a stereo-camera.

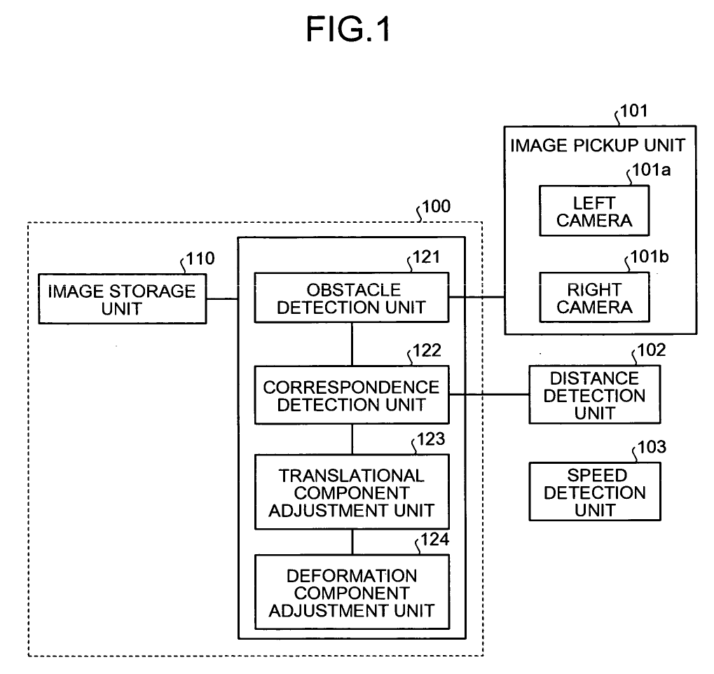

FIG. 1 is a block diagram showing a configuration of a calibration apparatus 100 according to the embodiment. As shown in FIG. 1, the calibration apparatus 100 includes an image storage unit 110, an obstacle detection unit 121, a correspondence detection unit 122, a translational component adjustment unit 123, and a deformation component adjustment unit 124. The calibration apparatus 100 is formed as a part of the obstacle detection apparatus including an image pickup unit 101, a distance detection unit 102, and a speed detection unit 103.

The image storage unit 110 is a storage apparatus such as an image memory in which plural images taken by the image pickup unit 101 are stored.

The image pickup unit 101 is mounted on the vehicle traveling on a road plane, and the image pickup unit 101 includes a left camera 101a and a right camera 101b, which take a stereo image in front of the vehicle. The left camera 101a and the right camera 101b have different view points, and the left camera 101a and the right camera 101b can take the image at the same time.

By way of simplest illustration, the embodiment is configured to have the two left and right cameras to transform the image of the left camera 101a into the image of the right camera 101b. However, it is possible to transform the image of the right camera 101b into the image of left camera 101a. Further, it is also possible to be configured to have at least three cameras to perform the transform between the images of the two cameras having a common viewing field.

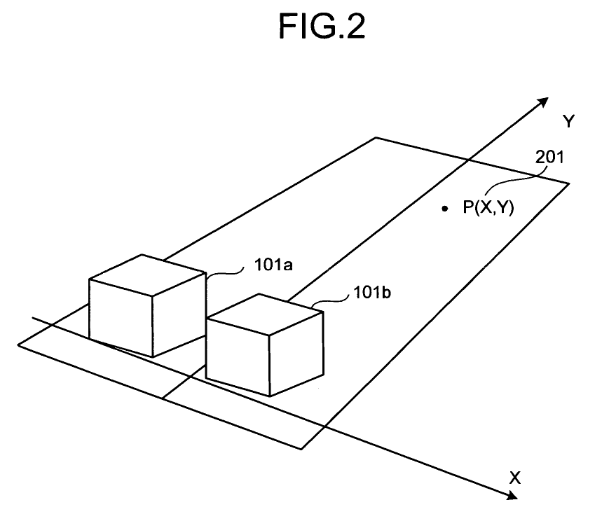

FIG. 2 is an explanatory view showing a relationship between an arrangement of the image pickup unit 101 and a road-plane coordinate. As shown in FIG. 2, the road-plane coordinate can be expressed by a coordinate system in which a vehicle traveling direction, i.e., an optical axis direction of the camera is set at an X-axis and a transverse direction is set at a Y-axis. The embodiment shall be based on the following premises. That is, in the left camera 101a and the right camera 101b, fore-and-aft misregistration is small, the optical axes are substantially parallel to each other, the optical axes are horizontally orientated forward, and an ordinate is substantially parallel to a vertical line.

A Z-axis (not shown in FIG. 2) is the axis in a vertical direction orthogonal to the X-axis and the Y-axis. In the three-dimensional space expressed by the X-axis, the Y-axis, and the Z-axis, the plane expressed by Z=0 corresponds to the road plane. The transform parameter which establishes the correspondence of a point P 201 on the road plane, expressed by the coordinate (X, Y), between the images of the right and left cameras is used in the planar projection stereopsis method.

The distance detection unit 102 is the distance measuring apparatus, such as the millimeter wave radar and the laser radar, which is mounted on the vehicle identical to the vehicle equipped with the image pickup unit 101. The distance detection unit 102 measures the distance such that the distance detection unit 102 emits a radio wave, a light beam, or the like to measure a time during which the radio wave, the light beam, or the like is reflected by the obstacle existing ahead and returned to the distance detection unit 102. In the distance measuring method, when compared with the distance measurement in which the stereo image taken by the camera is used, although the distance can be measured with high accuracy, the resolution in the spatial direction is low. For example, the spatial resolution of the VGA-size (640×480) image in which the range of horizontal view angle of 30 degrees is taken by the camera is about 0.05 degree per one pixel in the horizontal direction, while the number of pieces of distance data sampled from the same view angle is about 10 and the spatial resolution is about one to about three samples in the millimeter wave radar.

The speed detection unit 103 measures the traveling speed of the vehicle. For example, the speed detection unit 103 can be configured to count the number of revolutions of a wheel per constant speed to measure the traveling velocity of the vehicle. The speed detection unit 103 may be configured to measure the traveling velocity of the vehicle by measuring the distance to a rest object on a roadside with the device such as the millimeter wave radar and the laser radar included in the distance detection unit 102. The speed measuring method is not limited to the above examples, but any speed measuring method can be applied as long as the method can measure the speed of the traveling vehicle.

The obstacle detection unit 121 utilizes the planar projection stereopsis method to detect the obstacle. On the assumption that the point on the image taken by the left camera 101a exists on the road plane, the obstacle detection unit 121 transforms the point into the image of the right camera 101b using the transform parameter. When the difference in brightness between the images exceeds a predetermined threshold, the obstacle detection unit 121 determines that the point belongs to the obstacle region.

In the embodiment, the strict adjustment of the transform parameter is not performed to the individual vehicle in the vehicle production process, but a predetermined initial value is given to each type of the vehicle. Accordingly, the error of the transform parameter is large in an initial operation stage of the vehicle, and sometimes the detection error of the obstacle is increased. However, the adjustment and update of the transform parameter are repeated by applying the technique of the invention, which allows the accuracy of the obstacle detection to be improved.

The correspondence detection unit 122 establishes the correspondence between the results of the distance detection unit 102 and the obstacle detection unit 121. When the difference between the distance to the obstacle computed by the obstacle detection unit 121 and the distance detected by the distance detection unit 102 is not more than a predetermined threshold, the correspondence detection unit 122 determines that the obstacle detection result corresponds to the distance detection result, and the correspondence detection unit 122 outputs position coordinate information and distance information. The position coordinate information means the information on the position in a camera coordinate system of the obstacle detected by the obstacle detection unit 121, and the distance information means the information on the distance to the obstacle detected by the distance detection unit 102.

The translational component adjustment unit 123 computes a vanishing-point coordinate in the image by using speed information output from the speed detection unit 103 and the position coordinate information and distance information output from the correspondence detection unit 122, and thereby the translational component adjustment unit 123 computes a translational component. The translational component is included in the transform parameter, and the translational component is the parameter concerning the image translation.

After the deformation component adjustment unit 124 translates the right and left images such that the vanishing points coincide with each other by using the vanishing-point coordinate computed by the translational component adjustment unit 123, the deformation component adjustment unit 124 computes a deformation component. The deformation component is included in the transform parameter, and the deformation component is the parameter concerning the image deformation.

Then, the translational component and the deformation component of the transform parameter in the planar projection stereopsis method will be explained in detail. Assuming that the point (X, Y, Z) in the three-dimensional space to the projection target in the image is set at (u, v), generally equation (1) holds:

$$u = \frac{{h}_{11} X + {h}_{12} Y + {h}_{13} Z + {h}_{14}}{{h}_{31} X + {h}_{32} Y + {h}_{33} Z + {h}_{34}} , \\ v = \frac{{h}_{21} X + {h}_{22} Y + {h}_{23} Z + {h}_{24}}{{h}_{31} X + {h}_{32} Y + {h}_{33} Z + {h}_{34}} \qquad ( 1 )$$

Because the planar projection stereopsis method involves the point P=(X, Y, 0) on the road plane of Z=0, equation (1) is simplified as shown in equation (2) by substituting Z=0:

$$u = \frac{{h}_{11} X + {h}_{12} Y + {h}_{14}}{{h}_{31} X + {h}_{32} Y + {h}_{34}} , \\ v = \frac{{h}_{21} X + {h}_{22} Y + {h}_{24}}{{h}_{31} X + {h}_{32} Y + {h}_{34}} \qquad ( 2 )$$

where h₁₁ to h₃₄ are the parameter determined by the position or the direction to a world coordinate system of the camera, a focal distance of a camera lens, an image origin, and the like. Because the same camera model is expressed even if h₁₁ to h₃₄ of constant-times operation is performed, generality is not lost even if an arbitrary element of h₁₁ to h₃₄ is set at 1. Therefore, the following description will be made while h₃₂ is set at 1.

The expression h₃₁X+h₃₂Y+h₃₄ which is of a denominator of equation (2) indicates the distance between an eye point of the camera and the point P 201 in FIG. 2, i.e., a depth. In the calibration apparatus 100 according to the embodiment, since the optical axis of the stereo-camera is arranged so as to be orthogonal to the X-axis, it can be assumed that the depth is independent of X. Therefore, equation (2) can be approximated by equation (3) by substituting h₁₁=0:

$$u = \frac{{h}_{11} X + {h}_{12} Y + {h}_{14}}{Y + {h}_{34}} , \\ v = \frac{{h}_{21} X + {h}_{22} Y + {h}_{24}}{Y + {h}_{34}} \qquad ( 3 )$$

Then, letting Y_{c}=Y+h₃₄ leads to equation (4):

$$\vec{u} = [ \begin{matrix}u \\ v\end{matrix} ] = [ \begin{matrix}{h}_{11} & {h}_{14} & - {h}_{34} {h}_{12} \\ {h}_{21} & {h}_{24} & - {h}_{34} {h}_{22}\end{matrix} ] [ \begin{matrix}\frac{X}{{Y}_{c}} \\ \frac{1}{{Y}_{c}}\end{matrix} ] + [ \begin{matrix}{h}_{12} \\ {h}_{22}\end{matrix} ] \qquad ( 4 )$$

When the coordinate of the vanishing point (projection target at an infinite-point where Y becomes infinity) is expressed by equation (5), the coordinate of the vanishing point is expressed by equation (6) from equation (4), where T is a transpose:
\vec{t}=(u₀,v₀)^{T} (5)
\vec{t}=(h₁₂,h₂₂)^{T} (6)

Letting the matrices on the right side of equation (4) be M and using a vector represented by equation (7) leads to equation (8):

$$\begin{matrix} \vec{X} = {( \frac{X}{{Y}_{c}} , \frac{1}{{Y}_{c}} )}^{T} & ( 7 ) \\ \vec{u} - \vec{t} = M \vec{X} & ( 8 )\end{matrix}$$

Because this relationship holds for both the right and left images, when the projection targets of the point P on the road plane to the right and left images are expressed by equation (9) respectively, equation (10) holds:
\vec{u}ₗ,\vec{u}ᵣ (9)
\vec{u}ₗ−\vec{t}ₗ=Mₗ\vec{X} \vec{u}ᵣ−\vec{t}ᵣ=Mᵣ\vec{X} 10)

This leads to equation (11):
\vec{u}ᵣ−\vec{t}ᵣ=A(\vec{u}ₗ−\vec{t}ₗ), A=MᵣMₗ⁻¹ (11)

That is, it is found that the right and left images in which the road plane is taken have the relationship of affine transform. In the embodiment, for the transform parameter of equation (11), a predetermined value is imparted as an initial value in each type of the vehicle at the time when the camera is installed in the vehicle, and the later-mentioned transform parameter adjustment process is performed to adjust the value as needed during the operation of the vehicle.

Then, it is assumed that the road plane is changed from Z=0 to Z=pY by the road inclination or the vehicle vibration. In this case, equation (3) for Z=0 is deformed in equation (12):

$${u}^{′} = \frac{{h}_{11} X + ( {h}_{12} + p {h}_{13} ) Y + {h}_{14}}{Y + p {h}_{33} Y + {h}_{34}} , \\ {v}^{′} = \frac{{h}_{21} X + ( {h}_{22} + p {h}_{23} ) Y + {h}_{24}}{Y + p {h}_{33} Y + {h}_{34}} \qquad ( 12 )$$

Letting Y_{c}=Y+h₃₄ leads to equation (13):

$$[ \begin{matrix}{u}^{′} \\ {v}^{′}\end{matrix} ] = [ \begin{matrix}{h}_{11} & {h}_{14} & - {h}_{34} ( {h}_{12} + p {h}_{13} ) \\ {h}_{21} & {h}_{24} & - {h}_{34} ( {h}_{22} + p {h}_{23} )\end{matrix} ] [ \begin{matrix}\frac{X}{{Y}_{c}} \\ \frac{1}{{Y}_{c}}\end{matrix} ] + [ \begin{matrix}{h}_{12} + p {h}_{13} \\ {h}_{22} + p {h}_{23}\end{matrix} ] \qquad ( 13 )$$

In this case, when the vanishing-point coordinate is expressed by equation (14), equation (15) is obtained:
\vec{t}=(\vec{u}₀′,v₀′)^{T} (14)
\vec{t}′=(h₁₂+ph₁₃,h₂₂+ph₂₃)^{T} (15)

As can be seen from equation (15), the vanishing point is moved on a constant straight line by the road inclination or the vehicle vibration. When equation (14) which is of the vanishing-point coordinate is used, equation (13) can be expressed by equation (16):

$${\vec{u}}^{′} = [ \begin{matrix}{u}^{′} \\ {v}^{′}\end{matrix} ] = [ \begin{matrix}{h}_{11} & {h}_{14} & - {h}_{34} {u}_{0}^{′} \\ {h}_{21} & {h}_{24} & - {h}_{34} {v}_{0}^{′}\end{matrix} ] [ \begin{matrix}\frac{X}{{Y}_{c}} \\ \frac{1}{{Y}_{c}}\end{matrix} ] + [ \begin{matrix}{u}_{0}^{′} \\ {v}_{0}^{′}\end{matrix} ] \qquad ( 16 )$$

Equation (18) is obtained by using equation (17):

$$\begin{matrix}\{ \begin{matrix} d \vec{u} = \vec{u} - \vec{t} \\ d {\vec{u}}^{′} = {\vec{u}}^{′} - {\vec{t}}^{′} \\ {du}_{0} = {u}_{0} - {u}_{0}^{′} \\ {dv}_{0} = {v}_{0} - {v}_{0}^{′} \\ d \vec{t} = \vec{t} - {\vec{t}}^{′}\end{matrix} & ( 17 ) \\ \begin{matrix}d {\vec{u}}^{′} = [ \begin{matrix}{h}_{11} & {h}_{14} & - {h}_{34} {u}_{0} \\ {h}_{21} & {h}_{24} & - {h}_{34} {v}_{0}\end{matrix} ] [ \begin{matrix}\frac{X}{{Y}_{c}} \\ \frac{1}{{Y}_{c}}\end{matrix} ] + [ \begin{matrix}{h}_{34} ( {u}_{0} - {u}_{0}^{′} ) \\ {h}_{34} ( {v}_{0} - {v}_{0}^{′} )\end{matrix} ] [ \frac{1}{{Y}_{c}} ] \\ = M \vec{X} + {h}_{34} [ \begin{matrix}0 & {du}_{0} \\ 0 & {dv}_{0}\end{matrix} ] \vec{X} \\ = d \vec{u} + {h}_{34} \frac{d \vec{t}}{{Y}_{c}}\end{matrix} & ( 18 )\end{matrix}$$

Further, equation (21) is obtained by using equations (19) and (20):

$$\begin{matrix} \vec{X} = {M}_{- 1} d \vec{u} & ( 19 ) \\ {M}_{- 1} = [ \begin{matrix}{m}_{11} & {m}_{12} \\ {m}_{21} & {m}_{22}\end{matrix} ] & ( 20 ) \\ \frac{1}{{Y}_{c}} = {m}_{21} du + {m}_{22} dv & ( 21 )\end{matrix}$$

Therefore, equation (22) is obtained:

$$d {\vec{u}}^{′} = [ \begin{matrix}1 + {h}_{34} {m}_{21} {du}_{0} & {h}_{34} {m}_{22} {du}_{0} \\ {h}_{34} {m}_{21} {dv}_{0} & 1 + {h}_{34} {m}_{22} {dv}_{0}\end{matrix} ] d \vec{u} \qquad ( 22 )$$

Assuming that a yaw angle (rotation about the vertical axis) of the vehicle body is small, since h₃₄ is also small, equations (23) and (24) are substantially equal to each other even if the road inclination or the body vibration exists:
d\vec{u}′ (23)
d\vec{u} (24)
This shows that the road inclination does not cause the deformation of the image.

From the explanation of the geometric relationship between the road plane and the camera, it is found that the right image and the left image have the relationship of the affine transform, the image deformation is not generated by the road inclination or the vehicle vibration, only the translational component of the affine transform is changed, and the direction is constant in the change in translational component.

Thus, the inter-image transform parameters which are of the computation target in the embodiment are one which is necessary to transform the coordinate on the road plane appearing in one camera image into the corresponding point of the road plane appearing in the other camera image. Specifically, the transform parameters are the matrix A (deformation component) in equation (11) representing the image deformation and a translational movement amount (translational component) of the vanishing point.

Usually, in the production process, the road image is taken while the vehicle is placed on the flat road, the projection target coordinates of the on-road feature points such as a corner of a marking placed on the road to the right and left camera image are measured, and the transform parameters are computed from the pieces of coordinate information by applying a least square method. At least three feature points are required, and feature points more than three are used in order to improve the accuracy of the transform parameter.

When the vehicle production process is finished, usually there is no method of knowing whether the road surface on which the vehicle is currently running of stopping is flat or not, so that the calibration working cannot be performed. However, in the embodiment, since the transform parameters are sequentially adjusted and updated during the operation of the vehicle after the production process, it is sufficient that a predetermined parameter is imparted in each type of the vehicle in the production process, and the strict calibration working is not required.

Particularly, in the embodiment, the translational component of the transform parameter is computed from the distance information measured by the distance detection unit 102 during the actual operation of the vehicle and the position information of the obstacle measured by the obstacle detection unit 121 during the actual operation of the vehicle, and the deformation component of the transform parameter can be computed based on the computed translational component by the conventionally used method. Therefore, the calibration is not required between the distance detection unit 102 such as the radar and the obstacle detection unit 121, which allows the calibration working to be further simplified in the production process.

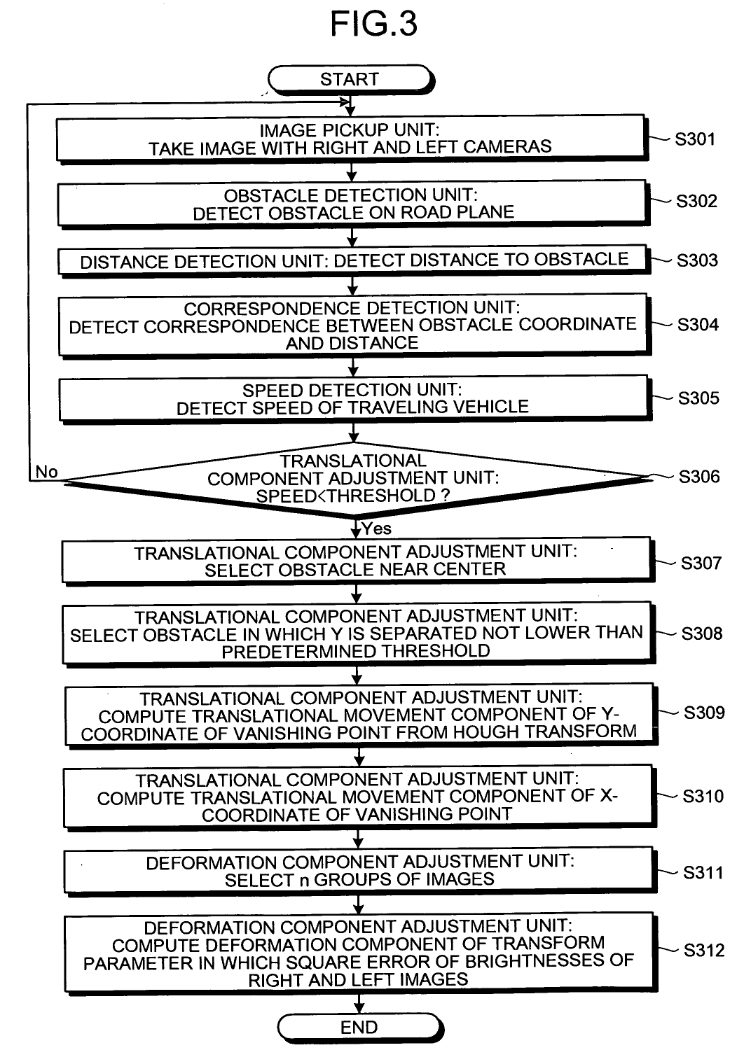

The transform parameter adjustment process with the calibration apparatus 100 according to the embodiment having the above configuration is explained below. FIG. 3 is a flowchart showing a whole flow of the transform parameter adjustment process in the calibration apparatus 100 according to the embodiment.

The image pickup unit 101 takes image in front of the vehicle with the right and left cameras (Step S301). The obstacle detection unit 121 detects the obstacle on the road plane from the right and left taken images by the planar projection stereopsis method (Step S302). The distance detection unit 102 detects the distance to the obstacle on the road plane (Step S303).

Then, the correspondence detection unit 122 computes the difference between the distance to the obstacle detected by the obstacle detection unit 121 and the distance to the obstacle detected by the distance detection unit 102. When the difference is not more than the predetermined threshold, the correspondence detection unit 122 determines that the distance detection result corresponds to the obstacle detection result, and the correspondence detection unit 122 outputs the combination of the pieces of position coordinate information (u, v) and (u′, v′) on the right and left camera images of the obstacle detected by the obstacle detection unit 121 and the distance information Y measured by the distance detection unit 102 (Step S304).

Then, the speed detection unit 103 detects the speed of the traveling vehicle (Step S305), and the translational component adjustment unit 123 determines whether the detected speed is smaller than the predetermined threshold or not (Step S306). This is because, in order to eliminate influences such as inclination of the road and vibration of the vehicle, it is necessary that the transform parameter is computed on the assumption the vanishing point is standing still.

That is, while the vanishing-point position is changed by the vehicle vibration or the road inclination during traveling the vehicle, the road inclination is not changed nor usually exist the vehicle vibration during stopping the vehicle, so that it is thought that the position of the vanishing point stands still. Therefore, the translational component adjustment unit 123 compares the vehicle speed to the predetermined constant threshold to determine whether the vehicle is stopped or not. When the vehicle is stopped, the translational component adjustment unit 123 estimates the vanishing-point position from the following process. However, it is not necessary that the vehicle is strictly stopped, and the vehicle speed is required to an extent in which the road inclination or the vehicle vibration can be removed. The speed is previously determined as the threshold, and the threshold is used for comparison during the transform parameter adjustment.

In Step S306, when the detected speed is larger than the predetermined threshold, the transform parameter adjustment is not performed, the flow returns to the first Step S301 to repeat the process (No in Step S306).

When the detected speed is smaller than the predetermined threshold (Yes in Step S306), the translational component adjustment unit 123 selects the position coordinate information of the obstacle near the center of the image from the position coordinate information of the obstacle of which the correspondence detection unit 122 establishes the correspondence (Step S307). This is because it can be assumed that the obstacle near the center of the image is the vehicle traveling ahead.

Then, the translational component adjustment unit 123 selects the obstacle, in which Y is separated away not lower than a predetermined threshold, from the selected obstacles (Step S308). This is because the vanishing point computation is performed using the position coordinate information of the vehicle traveling ahead before and after the movement on the assumption that the vehicle traveling ahead is moved while the vehicle is stopped.

Then, the translational component adjustment unit 123 computes the translational movement component of the Y-coordinate of the vanishing point by utilizing general Hough transform (Step S309), and the translational component adjustment unit 123 computes the translational movement component of the X-coordinate of the vanishing point using the computed translational movement component of the Y-coordinate (Step S310). The method of computing the translational movement component of the Y-coordinate of the vanishing point is explained in detail below.

h₂₁ is small since the camera is substantially horizontally installed, and X which is of the coordinate value in the transverse direction on the road is also small since the obstacle is located near the center of the image. Therefore, the y-component of equation (4) representing the relationship between the position coordinate information and the distance information can be approximated by equation (25):

$$v = \frac{( {h}_{24} - {h}_{34} {h}_{22} )}{( Y + {h}_{34} )} + {h}_{22} \qquad ( 25 )$$

where v is a y-coordinate value of the point in the image and Y is the distance to the obstacle detected by the distance detection unit 102.

The position coordinate information, selected in Step S307 on the obstacle near the center of the image, and the distance information are set at (v₀,Y₀) and (v₁,Y₁). Letting a=h₂₂ and b=h₂₄−h₃₄h₂₂ in equation (25) leads to the relationship between a and b represented by equation (26):

$$( a - {v}_{0} ) ( a - {v}_{1} ) = b \frac{( {v}_{0} - {v}_{1} )}{( {Y}_{1} - {Y}_{0} )} \qquad ( 26 )$$

The value of a, i.e., the vertical coordinate of the vanishing point can be determined from the relationship of equation (26) by the Hough transform. In the Hough transform, a two-dimensional array in which the two values of a and b are set at the coordinate axes is prepared, and the two-dimensional array represents a voting space. The value of a can be represented by equation (27) using b which is of the solution of the quadratic equation of equation (26):

$$a = \frac{1}{2} \{ ( {v}_{0} + {v}_{1} ) \pm \sqrt{{( {v}_{0} + {v}_{1} )}^{2} - 4 b \frac{( {v}_{0} - {v}_{1} )}{( {Y}_{1} - {Y}_{0} )}} \} \qquad ( 27 )$$

Because the solutions of a and b exist on the two curves represented by equation (27) in the voting space of the Hough transform, the voting to an array element on the curve representing the solution, namely 1 is added to the array element when equation (27) has a real solution.

Because the addition to the array elements representing the solutions of a and b becomes large when the voting is repeated, the coordinates having the maximum elements of the array are set at the solutions of a and b. Practically the threshold is determined according to the number of samples used for the voting, and the coordinate is determined as the solution when the maximum element exceeds the threshold.

Thus, a=h₂₂, i.e., the y-coordinate of the vanishing point is found. h₃₄ can be computed by applying the values of a and b to equation (25), which allows the value of Y_{c} (=Y+h₃₄) to be also computed.

The above vanishing point y-coordinate computing process is one which can be applied to the one camera. Accordingly, the translational movement component of the Y-coordinate of the vanishing point can also be determined by computing the vanishing point y-coordinates for the right and left cameras.

The translational movement component of the X-coordinate of the vanishing point is computed as follows. In the embodiment, it is assumed that the camera is substantially horizontally orientated forward and the ordinate axis of the image pickup plane is orientated toward the vertical direction. Therefore, the x-component of equation (4) can be approximated by equation (28):

$$u = {h}_{11} \frac{X}{{Y}_{c}} + {h}_{12} \qquad ( 28 )$$

The y-coordinates of the vanishing points on the images detected by the right and left cameras are caused to coincide with each other, and the difference in X-coordinate between the obstacles detected by the right and left cameras is taken, which obtains equation (29):

$$du = u - {u}^{′} = {h}_{11} \frac{D}{{Y}_{c}} + ( {h}_{12} - {h}_{12}^{′} ) \qquad ( 29 )$$

where D is the distance between the setting positions of the right and left cameras.

As described above, Y_{c} can be computed from the distance information measured with the distance detection unit 102 by computing the vanishing point y-coordinate. When the plural combinations of the position coordinate information u and u′ of the obstacle obtained by the correspondence detection unit 122 and the distance information Y_{c} are given, h₁₂−h′₁₂ representing the translational movement component of the vanishing point X-coordinate can be computed.

Through the above method, the translational movement amount of the vanishing point, i.e., the translational component of the transform parameter can be computed from the position coordinate information of the obstacle detected by the obstacle detection unit 121 and the distance information detected by the distance detection unit 102.

Then, the deformation component adjustment unit 124 computes the matrix A of equation (11) which is of the deformation component in the transform parameter. The deformation component adjustment unit 124 randomly selects n groups of images from the right and left camera images (Step S311). Then, the deformation component adjustment unit 124 computes the deformation component of the transform parameter, in which a square error between the brightnesses of the right and left images becomes the minimum, by using the pieces of information on the selected n groups of images (Step S312). The detailed computation method is explained below.

Each element of the matrix A is represented by equation (30):

$$A = [ \begin{matrix}{a}_{11} & {a}_{12} \\ {a}_{21} & {a}_{22}\end{matrix} ] \qquad ( 30 )$$

The vanishing point computed by the translational component adjustment unit 123 is set at the origin in the right and left camera images.

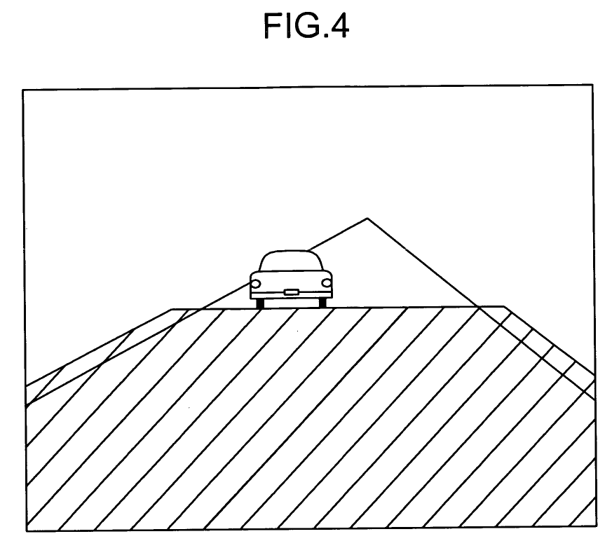

Then, a mask image with which the region having high probability where the road appears in the left image is prepared. FIG. 4 is a schematic view showing an example of the mask image used in computing the deformation component. As shown in FIG. 4, for example, the driving lane existing at the back of the vehicle traveling ahead is selected as the mask image.

Then, n groups of images are randomly selected from the right and left camera images taken while it is determined that the vehicle stands still, and the left images are set Iᵢ and right images are set at I′ᵢ (i=1 to n). Assuming that the coordinate of the pixel within the mask in the left image is set at (u, v) and the corresponding pixel of the right image is set at (u′, v′), equation (31) hold:
(u′,v′)=(a₁₁u+a₁₂v,a₂₁u+a₂₂V) (31)

When the value of the matrix A is correct, the value of equation (32) which is of the square error of the right and left images becomes the minimum:

$$e = {\sum }_{i = 1}^{n} {\sum }_{v = 1}^{h} {\sum }_{u = 1}^{w} {\{ {I}_{i} ( u , v ) - {I}_{i}^{′} ( {u}^{′} , {v}^{′} ) \}}^{2} \qquad ( 32 )$$

where h and w indicate the numbers of pixels in the vertical direction and in the horizontal direction respectively.

That is, the parameter giving the minimum of e is the optimum value of the matrix A representing the deformation component of the transform parameter. The parameter giving the minimum of e can be determined using the general optimization algorithm such as a steepest descent method.

The steepest descent method is started from an appropriately given initial value, and the parameter in jth repetition is represented by equation (33):
Pⱼ=[a₁₁(j),a₁₂(j),a₂₁(j),a₂₂(j)]^{T} (33)

In the steepest descent method, the update of the parameter is computed from a gradient of the function e near the coordinate (u′, v′) of the target correspondence by using equation (34):

$$∇ e ( {P}_{j} ) = \vert \begin{matrix}{\sum }_{i , u , v} \{ I ( u , v ) - {I}^{′} ( {u}^{′} , {v}^{′} ) \} \frac{\partial {I}^{′}}{\partial u} u \\ {\sum }_{i , u , v} \{ I ( u , v ) - {I}^{′} ( {u}^{′} , {v}^{′} ) \} \frac{\partial {I}^{′}}{\partial u} v \\ {\sum }_{i , u , v} \{ I ( u , v ) - {I}^{′} ( {u}^{′} , {v}^{′} ) \} \frac{\partial {I}^{′}}{\partial v} u \\ {\sum }_{i , u , v} \{ I ( u , v ) - {I}^{′} ( {u}^{′} , {v}^{′} ) \} \frac{\partial {I}^{′}}{\partial v} v\end{matrix} \vert \qquad ( 34 )$$

The value to which the update of the parameter is added is set at the parameter in (j+1)-th repetition. The (j+1)-th parameter is represented by equation (35):
Pⱼ₊₁=Pⱼ+∇e(Pⱼ) (35)

The optimum value of the element of the matrix A can be computed by repeating the above process until the update of the parameter becomes not more than the constant threshold. When the deformation component of the transform parameter is computed by the above process in Step S312, the transform parameter adjustment process is ended.

In the obstacle detection process performed after the transform parameter adjustment process, the transform parameter computed again through the transform parameter adjustment process is used. Therefore, the obstacle detection can be performed with higher accuracy.

Thus, in the calibration apparatus 100 according to the embodiment, the transform parameters can be computed from the position coordinate information on the obstacle detected by the obstacle detection unit 121 and the distance information detected by the distance detection unit 102. When the constant initial value is given in the production process, the transform parameter can be adjusted to the value having higher accuracy by computing the transform parameter again as needed during the vehicle operation. Therefore, the calibration is simplified in the production process, which allows the long-term fluctuation in transform parameter to be dealt with. Further, the transform parameter is computed by using the distance information detected by the distance detection unit 102 such as the radar, the calibration is not required in order to adjust the correspondence between the camera and the radar or the like, which allows the calibration working to be simplified in the production process.

The calibration program executed by the calibration apparatus according to the embodiment is provided while previously incorporated in a ROM or the like.

The calibration program executed by the calibration apparatus according to the embodiment may be configured to be provided while recorded in a recording medium such as a CD-ROM, a flexible disk (FD), a CD-R, and a DVD (Digital Versatile Disk) which can be read by the computer in a file of an installable form or an executable form.

Further, the calibration program executed by the calibration apparatus according to the embodiment may be configured to be provided by storing the calibration program in the computer connected to a network such as the Internet and by downloading the calibration program through the network. The calibration program executed by the calibration apparatus according to the embodiment may be configured to be provided or distributed through the network such as the Internet.

The calibration program executed by the calibration apparatus according to the embodiment is formed in a module including the above units (the obstacle detection unit, the correspondence detection unit, the translational component adjustment unit, and the deformation component adjustment unit). When CPU (processor) which is of actual hardware executes the calibration program by reading the calibration program from the ROM, each unit of the calibration program is downloaded on a main storage device. Therefore, the obstacle detection unit, the correspondence detection unit, the translational component adjustment unit, and the deformation component adjustment unit are generated on the main storage device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A calibration apparatus comprising:
an obstacle detection unit that detects an obstacle on an arbitrary surface in a three-dimensional space in one of a plurality of images obtained by taking an image pickup subject from a plurality of directions, by using a transform parameter transforming a point on the surface into a point on the surface of other image, and computes position coordinates of the obstacle on each of the images; and
a transform parameter adjustment unit that receives a distance data between an image pickup position and the obstacle, and adjusts the transform parameter with the received distance data and position coordinates of the detected obstacle,
wherein the obstacle detection unit detects the obstacle by using the transform parameter adjusted by the transform parameter adjustment unit, and computes the position coordinates of the detected obstacle.

2. The calibration apparatus according to claim 1, wherein the transform parameter includes a translational component which is of a parameter concerning image translation and a deformation component which is of a parameter concerning image deformation, and
the transform parameter adjustment unit includes a translational component adjustment unit that receives the distance data, and adjusts the translational component of the transform parameter with the received distance data and the position coordinates of the obstacle.

3. The calibration apparatus according to claim 1, wherein the transform parameter adjustment unit adjusts the transform parameter when a traveling speed of a vehicle on which the calibration apparatus is mounted is smaller than a predetermined threshold.

4. The calibration apparatus according to claim 1, wherein the transform parameter adjustment unit adjusts the transform parameter with the distance data to the obstacle within a predetermined range from the center of each of the images and from the position coordinate of the obstacle within a predetermined range from the center of each image of the plurality of images.

5. An obstacle detection apparatus comprising:
a plurality of image pickup units that take images;
a distance detection unit that detects a distance between an image pickup position and an obstacle on an arbitrary surface in a three-dimensional space;
an obstacle detection unit that detects the obstacle from the images taken by the image pickup units by using a transform parameter transforming a point on the surface in an image taken by one of the image pickup units into a point on the surface of an image taken by other image pickup unit, and computes position coordinates of the detected obstacle on the image; and
a transform parameter adjustment unit that receives the distance data, and adjusts the transform parameter with the received distance data and the position coordinates of the obstacle,
wherein the obstacle detection unit detects the obstacle from the images taken by the image pickup units by using the adjusted transform parameter, and
the obstacle detection unit computes the position coordinates of the detected obstacle.

6. The obstacle detection apparatus according to claim 5, wherein the transform parameter includes a translational component which is of a parameter concerning image translation and a deformation component which is of a parameter concerning image deformation, and
the transform parameter adjustment unit includes a translational component adjustment unit that receives the distance data, and adjusts the translational component of the transform parameter with the received distance data and the position coordinates of the obstacle.

7. The obstacle detection apparatus according to claim 5, further comprising a speed detection unit that detects traveling speed of a vehicle on which the image pickup units are installed,
wherein the transform parameter adjustment unit adjusts the transform parameter when the traveling speed of the vehicle is smaller than a predetermined threshold.

8. The obstacle detection apparatus according to claim 5, wherein the transform parameter adjustment unit adjusts the transform parameter with the distance data to the obstacle within a predetermined range from the center of the image and from the position coordinates of the obstacle within a predetermined range from the center of the image.

9. A calibration method comprising:
detecting an obstacle on an arbitrary surface in a three-dimensional space in one of a plurality of images obtained by taking an image pickup subject from a plurality of directions, by using a transform parameter transforming a point on the surface into a point on the surface of other image;
computing position coordinates of the obstacle on each of the images;
receiving a distance data between an image pickup position and the obstacle;
adjusting the transform parameter with the received distance data and position coordinates of the detected obstacle;
further detecting the obstacle by using the adjusted transform parameter; and
computing the position coordinates of the detected obstacle.

10. A computer program product having a computer readable medium including programmed instructions for calibration, wherein the instructions, when executed by a computer, cause the computer to perform:
detecting an obstacle on an arbitrary surface in a three-dimensional space in one of a plurality of images obtained by taking an image pickup subject from a plurality of directions, by using a transform parameter transforming a point on the surface into a point on the surface of other image;
computing position coordinates of the obstacle on each of the images;
receiving a distance data between an image pickup position and the obstacle;
adjusting the transform parameter with the received distance data and position coordinates of the detected obstacle;
further detecting the obstacle by using the adjusted transform parameter; and
computing the position coordinates of the detected obstacle.
